(19) United States
(12) Patent Application Publication
(10) Pub. No.: US 2024/0313831 A1
(43) Pub. Date: Sep. 19, 2024

(54) LINE OF SIGHT MULTIPLE-INPUT MULTIPLE-OUTPUT PRECODING BASED ON SLEPIAN SEQUENCES

(71) Applicant: QUALCOMM INCORPORATED, San Diego, CA (US)

(72) Inventors: Abdelrahman Mohamed Ahmed Mohamed Ibrahim, San Diego, CA (US); Juergen Cezanne, Ocean Township, NJ (US); Naga Bhushan, San Diego, CA (US); Renqiu Wang, San Diego, CA (US); Krishna Kiran Mukkavilli, San Diego, CA (US); Pinar Sen, San Diego, CA (US); Seyong Park, San Diego, CA (US); Muhammad Sayed Khairy Abdelghaffar, San Jose, CA (US); Yu Zhang, San Diego, CA (US)

(21) Appl. No.: 18/575,947

(22) PCT Filed: Aug. 18, 2021
(86) PCT No.: PCT/CN2021/113193

§ 371 Date: Jan. 2, 2024

(51) Int. Cl. H04B 7/0456

(52) U.S. Cl. CPC H04B 7/0456

(57) ABSTRACT

Methods, systems, and devices for wireless communications are described. A transmitter may select a precoder from a codebook for precoding one or more signals for transmission to a receiver. The transmitter may select the precoder from the codebook based on antenna configurations at the transmitter and the receiver. The precoder may be constructed using one or more Slepian sequences. In some implementations, the Slepian sequences may be associated with a quantity of transmit antennas at the transmitter. For instance, a length of each Slepian sequence may correspond to (for example, be equal to) a quantity of transmit antennas at the transmitter. Further, the Slepian sequences may be associated with a bandwidth within which to concentrate the one or more signals. Once the transmitter selects the precoder, the transmitter may precode the one or more signals and transmit the precoded signals to the receiver.

### CROSS REFERENCE

The present application is a 371 national stage filing of International PCT Application No. PCT/CN2021/113193 by Ibrahim et al. entitled “LINE OF SIGHT MULTIPLE-INPUT MULTIPLE-OUTPUT PRECODING BASED ON SLEPIAN SEQUENCES,” filed Aug. 18, 2021, which is assigned to the assignee hereof, and which is expressly incorporated by reference in its entirety herein.

### TECHNICAL FIELD

The following relates to wireless communications, including precoding for line of sight multiple-input multiple-output communications.

### DESCRIPTION OF THE RELATED TECHNOLOGY

Wireless communications systems are widely deployed to provide various types of communication content such as voice, video, packet data, messaging, broadcast, and so on. These systems may be capable of supporting communication with multiple users by sharing the available system resources (for example, time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

A wireless multiple-access communications system may include one or more base stations or one or more network access nodes, each simultaneously supporting communication for multiple communication devices, which may be otherwise known as user equipment (UE). Some wireless communications systems may support communications between wireless devices (for example, UEs and base stations) using multiple antennas (for example, multiple antennas at a transmitter and multiple antennas at a receiver). The communications between the wireless devices using the multiple antennas may be referred to as multiple-input multiple-output (MIMO) communications. In some cases, it may be appropriate for the transmitter supporting MIMO to determine a precoder for precoding signals for transmission to the receiver based on a channel state. In such cases that the transmitter and the receiver each include a relatively large number of antennas, however, the overhead of signals used to facilitate channel state measurements (for example, sounding reference signals (SRSs)) may be relatively high and improved techniques at the transmitter for precoding the signals for transmission to the receiver may be desirable.

### SUMMARY

The systems, methods and devices of this disclosure each have several innovative aspects, no single one of which is solely responsible for the desirable attributes disclosed herein.

One innovative aspect of the subject matter described in this disclosure can be implemented in a method for wireless communication. The method includes selecting a precoder from a codebook for precoding one or more signals for transmission to a second wireless communication device, where the precoder is based on one or more Slepian sequences associated with a quantity of transmit antennas at the first wireless communication device and a bandwidth within which to concentrate the one or more signals, precoding the one or more signals for transmission to the second wireless communication device using the selected precoder, and transmitting the precoded one or more signals to the second wireless communication device.

Another innovative aspect of the subject matter described in this disclosure can be implemented in a wireless communication device. The wireless communication device includes at least one modem, at least one processor, at least one memory communicatively coupled with the at least one processor and storing processor-readable code that, when executed by the at least one processor in conjunction with the at least one modem, is configured to select a precoder from a codebook for precoding one or more signals for transmission to a second wireless communication device, where the precoder is based on one or more Slepian sequences associated with a quantity of transmit antennas at the first wireless communication device and a bandwidth within which to concentrate the one or more signals, precode the one or more signals for transmission to the second wireless communication device using the selected precoder, and transmit the precoded one or more signals to the second wireless communication device.

### BRIEF DESCRIPTION OF THE DRAWINGS

FIG. 1 illustrates an example of a wireless communications system that supports line of sight (LOS) multiple-input multiple-output (MIMO) precoding based on Slepian sequences in accordance with aspects of the present disclosure.

FIG. 2 illustrates an example of antenna arrays at a transmitter and a receiver used for MIMO communications in accordance with aspects of the present disclosure.

FIG. 3 illustrates examples of different approaches for generating a precoder for MIMO communications in accordance with aspects of the present disclosure.

FIG. 4 illustrates an example of precoder candidates for LOS MIMO in accordance with aspects of the present disclosure.

FIG. 5 illustrates an example of a coordinate system used to describe prolate spheroidal wave functions in accordance with aspects of the present disclosure.

FIG. 6 illustrates an example of a graph of four Slepian sequences in accordance with aspects of the present disclosure.

FIG. 7 illustrates an example of a wireless communications system that supports LOS MIMO precoding based on Slepian sequences in accordance with aspects of the present disclosure.

FIG. 8 illustrates an example of spectral concentration of a Slepian sequence in accordance with aspects of the present disclosure.

FIG. 9 illustrates an example of a process flow that supports LOS MIMO precoding based on Slepian sequences in accordance with aspects of the present disclosure.

FIGS. 10 and 11 show block diagrams of devices that support LOS MIMO precoding based on Slepian sequences in accordance with aspects of the present disclosure.

FIG. 12 shows a block diagram of a communications manager that supports LOS MIMO precoding based on Slepian sequences in accordance with aspects of the present disclosure.

FIG. 13 shows a diagram of a system including a UE that supports LOS MIMO precoding based on Slepian sequences in accordance with aspects of the present disclosure.

FIG. 14 shows a diagram of a system including a base station that supports LOS MIMO precoding based on Slepian sequences in accordance with aspects of the present disclosure.

FIG. 15 shows a flowchart illustrating methods that support LOS MIMO precoding based on Slepian sequences in accordance with aspects of the present disclosure.

### DETAILED DESCRIPTION

Various aspects of the present disclosure relate to precoding for communications, such as line of sight (LOS) multiple-input multiple-output (MIMO) communications. A transmitter may select a precoder from a codebook for precoding one or more signals for transmission to a receiver. The transmitter may select the precoder from the codebook based on an antenna configuration at the transmitter and an antenna configuration at the receiver. The precoder may be constructed using one or more Slepian sequences. In some implementations, the Slepian sequences may be associated with a quantity of transmit antennas at the transmitter. For instance, a length of each Slepian sequence may correspond to (for example, may be equal to) a quantity of the transmit antennas at the transmitter. Further, the Slepian sequences may be associated with a bandwidth within which to concentrate the one or more signals. For instance, different Slepian sequences may be associated with different spectral concentration in different bandwidths (for example, with minimal sidelobe energy outside these bandwidths), and one or more Slepian sequences used to construct the precoder may be associated with a defined bandwidth. In some implementations, the transmitter may generate the Slepian sequences, construct the precoder, or both. In some other implementations, the Slepian sequences, the precoder, or both may be generated or constructed in advance, and the transmitter may identify or select the Slepian sequences, the precoder, or both from the pre-constructed Slepian sequences or precoder (for example, look up the Slepian sequences, the precoder, or both in the codebook).

Particular aspects of the subject matter described in this disclosure may be implemented to realize one or more of the following potential advantages. The techniques employed by the transmitter may allow for efficient precoding of one or more signals for transmission to a receiver with minimal overhead. In particular, the transmitter may not rely on signals (for example, sounding reference signals (SRSs)) from the receiver to determine a channel state before selecting the precoder. Instead, the transmitter may support codebook-based precoding, and the transmitter may select the precoder from the codebook with minimal signaling from the receiver, resulting in reduced overhead and reduced latency compared to alternative techniques. Further, because the precoder may be constructed using one or more Slepian sequences, the complexity associated with constructing the precoder may be reduced compared to alternative techniques (for example, compared to a complexity associated with constructing other precoders). As such, in the example that the transmitter is expected to construct the precoder, the transmitter may save power and processing time by constructing the precoder using one or more Slepian sequences, among other advantages.

Aspects of the disclosure are initially described in the context of wireless communications systems. Examples of processes and signaling exchanges that support LOS MIMO precoding based on Slepian sequences are then described. Aspects of the disclosure are further illustrated by and described with reference to apparatus diagrams, system diagrams, and flowcharts that relate to LOS MIMO precoding based on Slepian sequences.

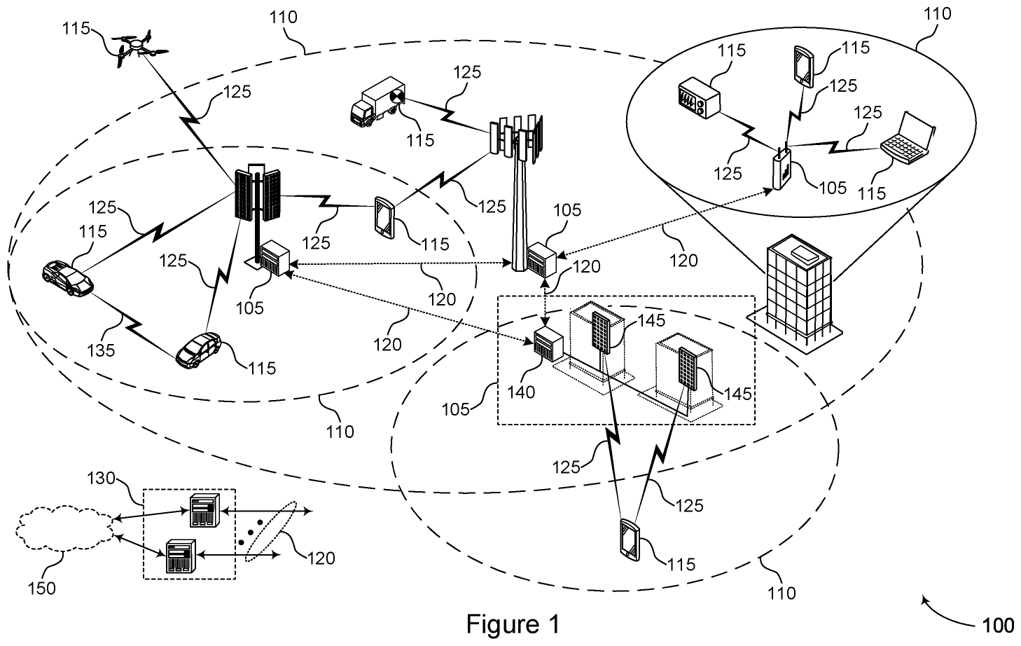

FIG. 1 illustrates an example of a wireless communications system 100 that supports LOS MIMO precoding based on Slepian sequences in accordance with aspects of the present disclosure. The wireless communications system 100 may include one or more base stations 105, one or more UEs 115, and a core network 130. In some examples, the wireless communications system 100 may be a Long-Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (for example, core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (for example, via an S1, N2, N3, or other interface). The base stations 105 may communicate with one another over the backhaul links 120 (for example, via an X2, Xn, or other interface) either directly (for example, directly between base stations 105), or indirectly (for example, via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (for example, a bandwidth part (BWP)) that is operated according to one or more physical layer channels for a given radio access technology (for example, LTE, LTE-A, LTE-A Pro, NR). Each physical layer channel may carry acquisition signaling (for example, synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (for example, in a carrier aggregation configuration), a carrier may also have acquisition signaling or control signaling that coordinates operations for other carriers. A carrier may be associated with a frequency channel (for example, an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (for example, of the same or a different radio access technology).

The communication links 125 shown in the wireless communications system 100 may include uplink transmissions from a UE 115 to a base station 105 (for example, in a physical uplink control channel (PUCCH) or a physical uplink shared channel (PUSCH)), or downlink transmissions from a base station 105 to a UE 115 (for example, in a physical downlink control channel (PDCCH) or a physical downlink shared channel (PDSCH)). Carriers may carry downlink or uplink communications (for example, in an FDD mode) or may be configured to carry downlink and uplink communications (for example, in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (for example, 1.4, 3, 5, 10, 15, 20, 40, or 80 megahertz (MHz)). Devices of the wireless communications system 100 (for example, the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (for example, a sub-band, a BWP) or all of a carrier bandwidth.

Signal waveforms transmitted over a carrier may be made up of multiple subcarriers (for example, using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (for example, a duration of one modulation symbol) and one subcarrier, where the symbol period and subcarrier spacing are inversely related. The number of bits carried by each resource element may depend on the modulation scheme (for example, the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (for example, spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (for example, 10 milliseconds (ms)). Each radio frame may be identified by a system frame number (SFN) (for example, ranging from 0 to 1023).

Each frame may include multiple consecutively numbered subframes or slots, and each subframe or slot may have the same duration. In some examples, a frame may be divided (for example, in the time domain) into subframes, and each subframe may be further divided into a number of slots. Alternatively, each frame may include a variable number of slots, and the number of slots may depend on subcarrier spacing. Each slot may include a number of symbol periods (for example, depending on the length of the cyclic prefix prepended to each symbol period). In some wireless communications systems 100, a slot may further be divided into multiple mini-slots containing one or more symbols. Excluding the cyclic prefix, each symbol period may contain one or more (for example, N_{f}) sampling periods. The duration of a symbol period may depend on the subcarrier spacing or frequency band of operation.

A subframe, a slot, a mini-slot, or a symbol may be the smallest scheduling unit (for example, in the time domain) of the wireless communications system 100 and may be referred to as a transmission time interval (TTI). In some examples, the TTI duration (for example, the number of symbol periods in a TTI) may be variable. Additionally, or alternatively, the smallest scheduling unit of the wireless communications system 100 may be dynamically selected (for example, in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (for example, a control resource set (CORESET)) for a physical control channel may be defined by a number of symbol periods and may extend across the system bandwidth or a subset of the system bandwidth of the carrier. One or more control regions (for example, CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (for example, control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (for example, using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (for example, a mobility management entity (MME), an access and mobility management function (AMF)) and at least one user plane entity that routes packets or interconnects to external networks (for example, a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (for example, radio heads and ANCs) or consolidated into a single network device (for example, a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (for example, less than 100 kilometers) compared to transmission using the smaller frequencies and longer waves of the high frequency (HF) or very high frequency (VHF) portion of the spectrum below: 300 MHZ.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHZ industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (for example, LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitter (for example, a transmitting device) via different antennas or different combinations of antennas. Likewise, the multiple signals may be received by the receiver (for example, a receiving device) via different antennas or different combinations of antennas. Each of the multiple signals may be referred to as a separate spatial stream and may carry bits associated with the same data stream (for example, the same codeword) or different data streams (for example, different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (for example, a base station 105, a UE 115) to shape or steer an antenna beam (for example, a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (for example, with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (for example, antenna panels) to conduct beamforming operations for directional communications with a UE 115. Some signals (for example, synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (for example, by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (for example, a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (for example, by a base station 105 or a UE 115) may be performed using multiple beam directions, and the device may use a combination of digital precoding or radio frequency beamforming to generate a combined beam for transmission (for example, from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (for example, a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (for example, a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (for example, for identifying a beam direction for subsequent transmission or reception by the UE 115) or for transmitting a signal in a single direction (for example, for transmitting data to a receiving device).

A receiving device (for example, a UE 115) may try multiple receive configurations (for example, directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (for example, different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (for example, when receiving a data signal). The single receive configuration may be aligned in a beam direction determined based on listening according to different receive configuration directions (for example, a beam direction determined to have a highest signal strength, highest signal-to-noise ratio (SNR), or otherwise acceptable signal quality based on listening according to multiple beam directions).

In some implementations, wireless devices in wireless communications system 100 may support one or more types of MIMO communications. For instance, the wireless devices may communicate using LOS MIMO, which may refer to MIMO communications on a channel with a clear LOS (for example, a channel with an LOS measurement satisfying a threshold). The wireless devices may also communicate using massive MIMO (MMIMO), which may refer to MIMO communications using a large number of antennas without a clear LOS (for example, with a non-LOS (NLOS) measurement satisfying a threshold). A channel used for MIMO communications may be modeled using, for example, a Rician channel model. The Rician channel model is shown in Equations 1-4 below, in which H refers to a characteristic of the channel. H_{LOS} may be an LOS component of the channel, and H_{NLOS} may be an NLOS component of the channel. The LOS component may be deterministic, and the NLOS component may come from reflections and scattering from an environment and may be random. The value of a may indicate an impact of the LOS component on the channel (for example, LOS percentage=a²), and the value of b may indicate an impact of the NLOS component on the channel.

$$H = {aH}_{LOS} + {bH}_{NLOS} \qquad ( 1 )$$

$${H}_{LOS} = \frac{exp ( - i 2 π \frac{{r}_{jk}}{λ} )}{\frac{{r}_{jk}}{λ}} \qquad ( 2 )$$

$${H}_{NLOS} ∈ \{ i . i . d . Rayleigh , CDL - x , TDL - x \} \qquad ( 3 )$$

$${a}^{2} + {b}^{2} = 1 \qquad ( 4 )$$

LOS MIMO may include communications using circular, one-dimensional, or two-dimensional antenna arrays, and MMIMO may include communications using one-dimensional or two-dimensional antenna arrays. LOS MIMO may also include communications on a channel with a channel matrix associated with a strong LOS component (for example, a>>b), and MMIMO may include communications on a channel with a weak LOS component (for example, a<b). In some examples, a transmitter may precode signals for LSM MIMO or MMIMO communications using a singular value decomposition (SVD)-based precoder. For LOS MIMO, the SVD-based precoder may be implicit and may be based on a special structure of a channel (for example, with limited to no channel state feedback), and, for MMIMO, the transmitter may compute or construct the SVD-based precoder using explicit channel state feedback.

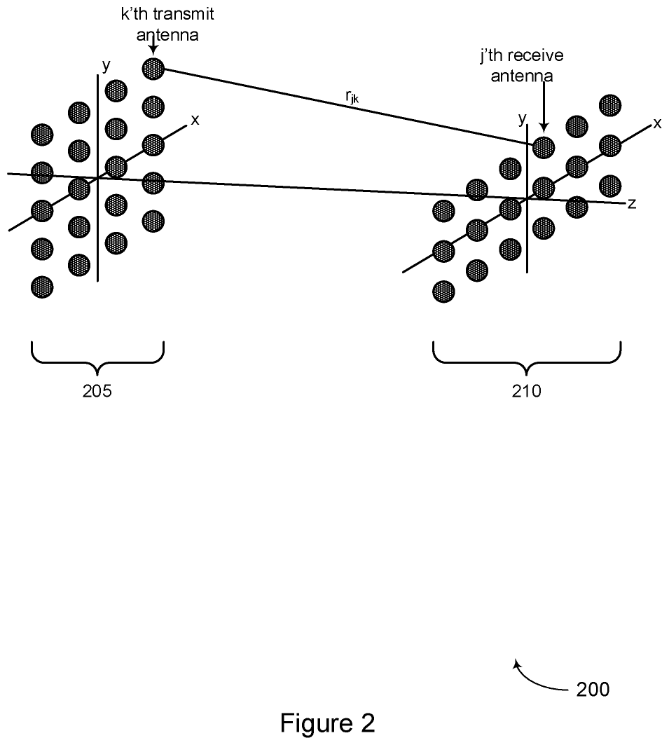

FIG. 2 illustrates an example of antenna arrays 200 at a transmitter and a receiver used for MIMO communications in accordance with aspects of the present disclosure. In some implementations, a structure of a LOS MIMO channel may be exploited to achieve high multiplexing gain.

Multiplexing gain may refer to a gain associated with MIMO communications (for example, compared to single-antenna communications). The LOS MIMO gain may decrease as distance between a transmitter and receiver increases. In FIG. 2, the LOS MIMO gain may decrease as rⱼₖ decreases, in which rⱼₖ corresponds to a distance between a k′th transmit antenna at the first antenna array 205 and a j′th receive antenna at the second antenna array 210. In some examples, multiplexing gain may vanish at 10000 lambda (for example, in which 1000 lambda=85 m for a 3.5 GHz channel). A maximum distance in which a transmitter may achieve LOS MIMO gain may depend on a product of transmit and receive antenna apertures. The aperture of an antenna array may correspond to a width of the antenna array. A spectral efficiency factor of an antenna array may be a ratio between an achievable spectral efficiency and a single-mode capacity (for example, log₂(1+Nᵣ×signal-to-noise ratio (SNR))), and the spectral efficiency factor may be an indicator of a spatial multiplexing gain.

In some aspects, LOS MIMO may provide a high multiplexing gain under one or more conditions. For instance, LOS MIMO may provide a high multiplexing gain in the example that a distance between transmit and receive antenna arrays fail to exceed a threshold that depends on apertures of the transmit and receive antennas and a carrier frequency. In addition, LOS MIMO may provide a high multiplexing gain in the example that a transmitter utilizes an accurate LOS MIMO precoder. An accurate LOS MIMO precoder may be based on channel knowledge at the transmitter, distance feedback to the transmitter, and a misalignment compensation (for example, compensation for misalignment between transmit and receive antenna arrays). In some examples, multiple deployment scenarios may have different constraints or uses for LOS MIMO. For instance, LOS MIMO may be used for communications in a backhaul link between a base station 105 and a relay (for example, an integrated access and backhaul (IAB), smart repeater, customer-provided equipment (CPE)). Additionally, or alternatively, LOS MIMO may be used for communications in an access link between a base station 105 or relay and a UE 115.

As mentioned, a transmitter may use feedback from a receiver (for example, channel state feedback) to construct a suitable precoder for precoding signals for transmission to the receiver. Such a precoder may be referred to as a closed-loop precoder. In some examples, however, the feedback used to construct the closed-loop precoder may incur overhead in a wireless communications system. Thus, in some implementations, a transmitter may use an open-loop precoder for LOS MIMO communications. For instance, the transmitter may use the open-loop precoder in the example that the transmitter is unable to accurately estimate a channel to derive a precoder. The open-loop precoder may refer to a precoder constructed without feedback from a receiver. The transmitter may use transmit and receive array configurations at the transmitter and the receiver to construct the open-loop precoder (for example, the transmitter may consider semi-open loop operation in the example that transmit and receive array configurations are known). Because the transmitter may use the transmit and receive array configurations to determine the open-loop precoder, the open-loop precoder may be referred to as a semi-open-loop precoder. The semi-open-loop precoder may differ from a fully-open-loop precoder since the fully-open-loop precoder may be selected with no knowledge at the transmitter. It may be challenging to exploit LOS MIMO gain for fully-open-loop operation without any knowledge about transmit and receive array configurations (for example, since there may be no universal precoder).

The transmitter may utilize the open-loop precoder for precoding signals for transmission to the receiver in the example that the receiver has little or no sounding capability or capability to transmit sounding reference signals (SRSs) (for example, a smart repeater with limited mobile terminated capabilities). In addition, the transmitter may utilize the open-loop precoder in the example that transmit and receive arrays at the transmitter and the receiver are aligned or in the example that the transmitter is capable of misalignment estimation and compensation (for example, the transmitter is able to estimate a misalignment between the transmit and receive arrays and compensate for the misalignment). Further, the transmitter may utilize the open-loop precoder to avoid high sounding overhead for large arrays (for example, receive arrays). For instance, the transmitter may utilize the open-loop precoder in the example that an overhead for indicating a misalignment estimation is less than a sounding overhead. The transmitter may also utilize the open-loop precoder for low-complexity operation (for example, to avoid the complexity associated with constructing a precoder based on feedback from the receiver).

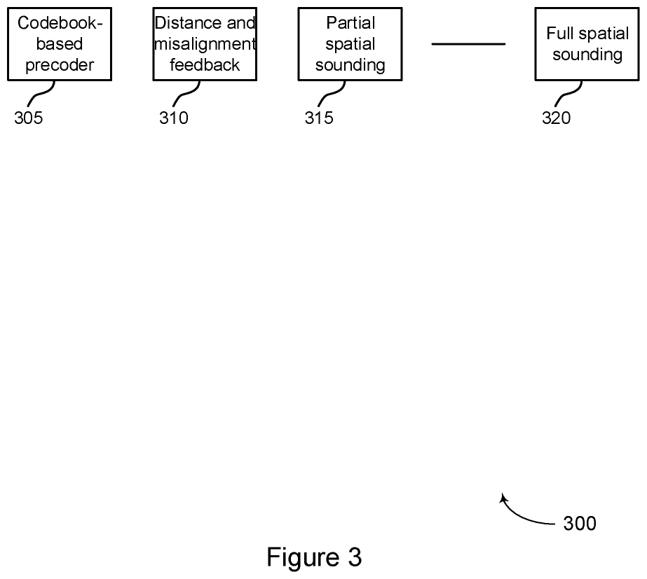

FIG. 3 illustrates examples of different approaches 300 for generating a precoder for MIMO communications in accordance with aspects of the present disclosure. The different approaches may be provided in order of increasing signaling overhead. In a first approach 305, a transmitter may utilize no feedback to determine a codebook-based precoder. In a second approach 310, the transmitter may utilize distance and misalignment feedback to construct a precoder. In a third approach 315, the transmitter may utilize partial spatial sounding to construct a precoder. In a fourth approach 320, the transmitter may utilize full spatial sounding to construct a precoder.

In wireless communications system 100, a transmitter may utilize a codebook-based precoder to exploit an LOS MIMO gain. An optimal precoder may be an SVD-based precoder based on full channel knowledge. However, the overhead to construct the optimal precoder may be high, so a transmitter in wireless communications system 100 may utilize sub-optimal precoders for MIMO communications, and the transmitter may derive the sub-optimal precoders based on limited feedback. As mentioned, the codebook-based precoder may be useful for scenarios in which a transmitter has access to limited feedback (for example, no sounding or limited sounding capability of a receiver, aligned transmit and receive antenna arrays or nodes with misalignment estimation or compensation capabilities, or low mobility scenarios in which receiver orientation is semi-static).

A codebook may be defined for a transmitter operating in an LOS MIMO mode, and the transmitter (for example, a base station 105, a relay, or a UE 115) may select a precoder based on configurations of transmit and receive antenna arrays at the transmitter and a receiver. For one-dimensional uniform linear arrays (ULAs) at the transmitter and the receiver, the transmitter may utilize a Legendre precoder in the example that Nᵣ≥Nₜ, and the transmitter may utilize a block-DFT precoder in the example that Nᵣ<Nₜ. For two-dimensional uniform rectangular arrays (URAs) at the transmitter and the receiver, each axis of the URAs may be seen as a one-dimensional array. For instance, the two-dimensional URAs may correspond to an N_{T}_{ₓ}×N_{T}_{_{y}} array at the transmitter and an N_{R}_{ₓ}×N_{R}_{_{y}} array at the receiver. Further, a Kronecker product of two one-dimensional arrays may correspond to a two-dimensional array. Thus, the transmitter may construct a two-dimensional precoder using a Kronecker product of Vₓ and V_{y}. Vₓ may be a one-dimensional precoder for a N_{R}_{ₓ}×N_{T}_{ₓ} channel, and V_{y} may be a one-dimensional precoder for a N_{R}_{_{y}}×N_{T}_{_{y}} channel.

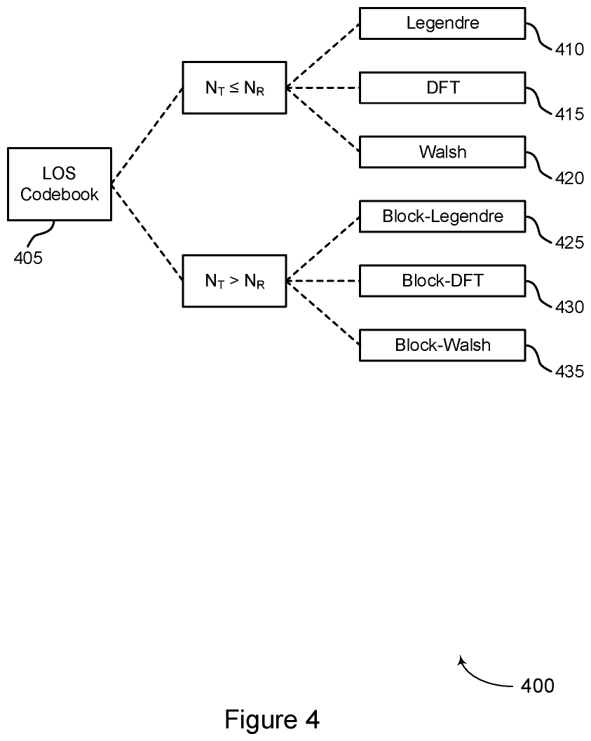

FIG. 4 illustrates an example of precoder candidates 400 for LOS MIMO (for example, including precoders based on Legendre polynomials) in accordance with aspects of the present disclosure. Each of the precoder candidates may be an example of a codebook-based precoder. A transmitter may determine a LOS codebook 405, and the transmitter may select a precoder from the LOS codebook 405 for precoding signals for transmission to a receiver. For instance, in the example that N_{T}≤N_{R}, the transmitter may select a Legendre precoder 410, a DFT precoder 415, or a Walsh precoder 420 from the LOS codebook 405. Alternatively, in the example that N_{T}>N_{R}, the transmitter may select a block-Legendre precoder 425, a block-DFT precoder 430, or a block-Walsh precoder 435 from the LOS codebook 405.

In addition to, or as an alternative to, the precoders in FIG. 4, a transmitter in wireless communications system 100 may utilize a Slepian precoder for precoding signals for transmission to a receiver. The Slepian precoder may be constructed based on one or more Slepian sequences. Slepian sequences may also be referred to as discrete prolate spheroidal sequences (DPSSs). In contrast to a Legendre precoder which is constructed using a QR decomposition operation, a simpler approach may be used to construct a Slepian precoder in which the Slepian precoder directly corresponds to one or more Slepian sequences. Further, the Slepian precoder may achieve a similar performance to a Legendre precoder.

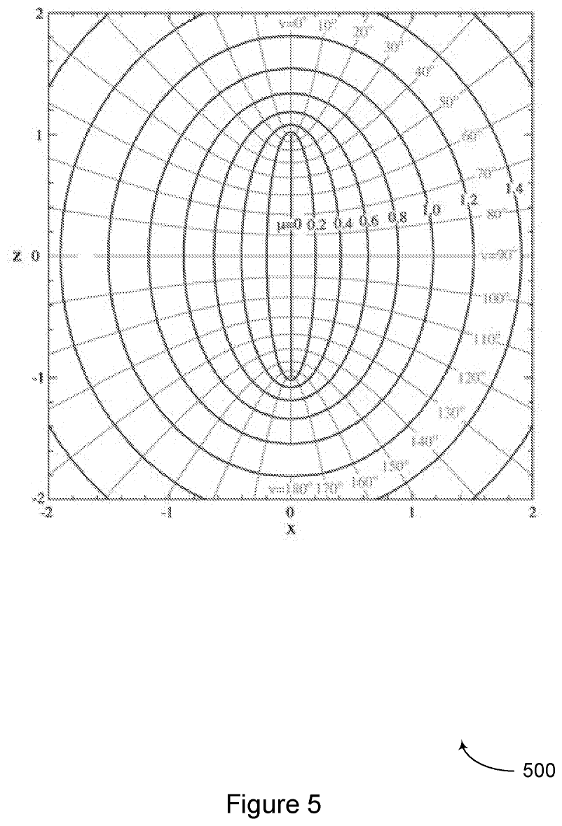

FIG. 5 illustrates an example of a coordinate system 500 used to describe prolate spheroidal wave functions (PSWFs) in accordance with aspects of the present disclosure. In particular, FIG. 5 illustrates an example of prolate spherical coordinates. In prolate spherical coordinates, for a ULA at a transmitter and a receiver, the PSWF may be orthogonal at the transmit and receive apertures. Thus, the PSWFs may be left and right eigen-functions for a continuous transmit and receive aperture. For a ULA with N elements, a precoder may be constructed using DPSSs (for example, Slepian sequences). In some examples, the prolate spheroidal coordinates (μ, v, φ) may be defined in accordance with Equations 5-7 below, in which u is a non-negative real number, νε[0,π], and the azimuthal angle φ belongs to the interval [0,2π].

$$x = a sinh μsin v cos φ \qquad ( 5 )$$

$$y = a sinh μsin v sin φ \qquad ( 6 )$$

$$z = a cosh μcos v \qquad ( 7 )$$

In some implementations, Slepian sequences may be used to solve a spectral concentration problem. For instance, a transmitter may select a Slepian sequence associated with a highest spectral concentration within a frequency range. That is, in selecting a Slepian sequence, the transmitter may select the Slepian sequence among all sequences{wₙ} for a given length N and frequency W such that a spectral concentration associated with the selected Slepian sequence is maximum (for example, maximum among the sequences {wₙ}). The selected Slepian sequence for which the spectral concentration is a maximum may correspond to a sequence for which a sidelobe energy outside a frequency band (for example, [−W, W]) is minimum.

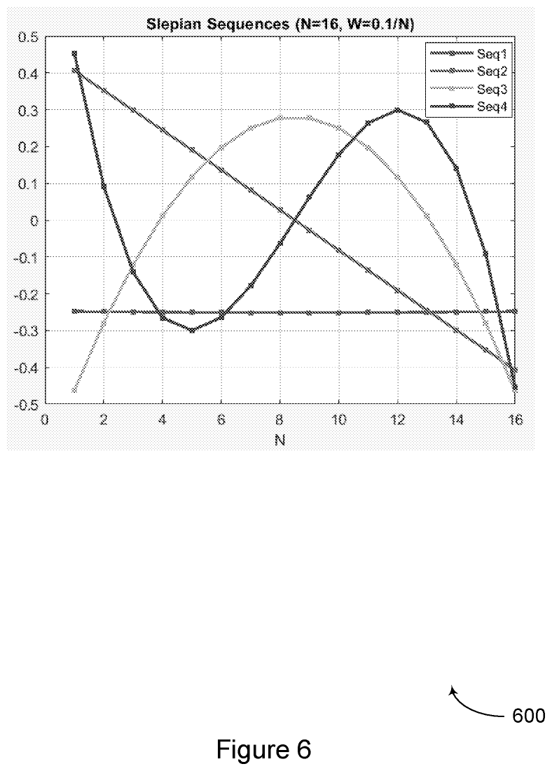

FIG. 6 illustrates an example of a graph 600 of four Slepian sequences for N=16 and W=0.1/N in accordance with aspects of the present disclosure. The optimal Slepian sequences from a set of Slepian sequences may correspond to eigenvectors of the N×N matrix in Equation 8 below. In some examples, a precoder, V, may be constructed by performing an SVD on an entry in the N×N matrix in Equation 8 such that V=SVD (A) (for example, to generate one or more Slepian sequences).

$$A ( n , m ) = \frac{sin ( 2 π W ( n - m ) )}{π ( n - m )} , n , m = 0 , ... , N - 1 \qquad ( 8 )$$

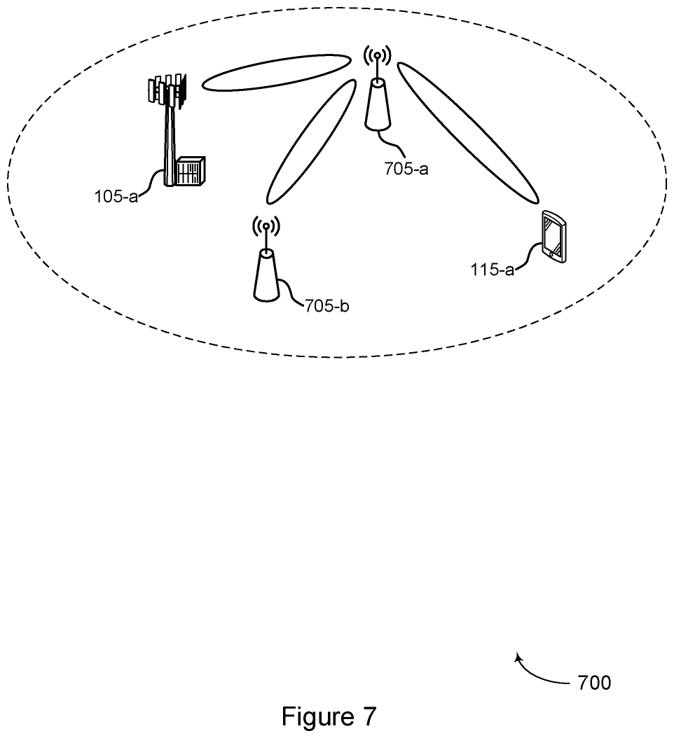

FIG. 7 illustrates an example of a wireless communications system 700 that supports LOS MIMO precoding based on Slepian sequences in accordance with aspects of the present disclosure. The wireless communications system 700 includes a UE 115-a, which may be an example of a UE 115 described with reference to FIGS. 1-6. The wireless communications system 700 also includes a base station 105-a, which may be an example of a base station 105 described with reference to FIGS. 1-6. The wireless communications system 700 also includes a first relay 705-a and a second relay 705-b, which may relay communications between the base station 105-a and the UE 115-a. The UE 115-a, the base station 105-a, the first relay 705-a, and the second relay 705-b may each correspond to a transmitter or a transmitting device described herein. The wireless communications system 700 may implement aspects of wireless communications system 100. For example, the wireless communications system 700 may support efficient techniques for precoding for LOS MIMO communications.

In FIG. 7, a transmitter may select a precoder from a codebook for precoding one or more signals for transmission to a receiver. The transmitter may select the precoder from the codebook based on an antenna configuration at the transmitter and an antenna configuration at the receiver. The precoder may be constructed using one or more Slepian sequences. In some implementations, the Slepian sequences may be associated with a quantity of transmit antennas at the transmitter. For instance, a length of each Slepian sequence, N, may be equal to a quantity of transmit antennas at the transmitter. Further, the Slepian sequences may be associated with a bandwidth, W, within which to concentrate the one or more signals. In some examples, the bandwidth or interval W may be selected to be a small value (for example, W=0.1/N). Slepian sequences based on a small value of W may have a similar spectral concentration at distances at which the transmitter may be expected to transmit (for example, distances of interest, such as 1000 lambda). This similar spectral concentration may be seen by comparing a spectral concentration of a Slepian sequence with a first singular vector of a LOS channel model at distances of 100 and 1000 lambda.

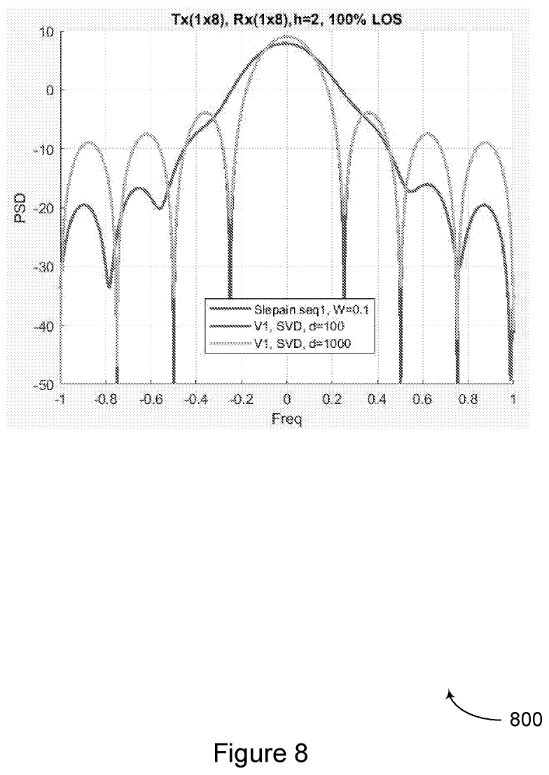

FIG. 8 illustrates an example of spectral concentration 800 of a Slepian sequence based on a small value of W in accordance with aspects of the present disclosure.

As mentioned, a codebook may be defined for a transmitter operating in an LOS MIMO mode in wireless communications system 700, and the transmitter (for example, a base station 105, a relay, or a UE 115) may select a precoder from the codebook for precoding signals for transmission to a receiver. In some implementations, the transmitter and the receiver may include uniform arrays with NT antennas at the transmitter and N, antennas at the receiver.

For ULAs communicating on a LOS MIMO channel, the transmitter may use a Slepian precoder in the example that Nᵣ≥Nₜ, and the transmitter may utilize a block-Slepian precoder in the example that Nᵣ<Nₜ. One example of a block-Slepian precoder is given in Equation 9 below, in which V is a Slepian precoder.

$${V}_{blk \_ slepian} = \frac{1}{\sqrt{{N}_{t}}} [ \begin{matrix}{V}_{{N}_{r} \times {N}_{r}} & 0 \\ ... & 0 \\ {V}_{{N}_{r} \times {N}_{r}} & 0\end{matrix} ] \qquad ( 9 )$$

For two-dimensional URAs communicating on a LOS MIMO channel, each axis of the URAs may be seen as a one-dimensional array. For instance, the two-dimensional URAs may correspond to an N_{T}_{ₓ}×N_{T}_{_{y}} array at the transmitter and an N_{R}_{ₓ}×N_{R}_{_{y}} array at the receiver. Further, a Kronecker product of two one-dimensional arrays may correspond to a two-dimensional array. Thus, the transmitter may construct a two-dimensional precoder using a Kronecker product of V_{N}_{_{Tx}}_{×N}_{_{Rx}} and V_{N}_{_{Ty}}_{×N}_{_{Ry}}, in which V_{N}_{_{Tx}}_{×N}_{_{Rx}} may be a one-dimensional precoder for a N_{R}_{ₓ}×N_{T}_{ₓ} channel, and V_{N}_{_{Ty}}_{×N}_{_{Ry}} may be a one-dimensional precoder for a N_{Ry}×N_{Ty} channel. In particular, V_{N}_{_{Tx}}_{×N}_{_{Rx}} may be a precoder for a one-dimensional array in an x-axis, and V_{N}_{_{Ty}}_{×N}_{_{Ry}} may be a precoder for a one-dimensional array in a y-axis. Thus, the constructed two-dimensional precoder may be as shown in Equation 10, in which ⊗ is the Kronecker product operator.

$${V}_{2 D} = {V}_{{N}_{Tx} \times {N}_{Rx}} ⊗ {V}_{{N}_{Ty} \times {N}_{Ry}} \qquad ( 10 )$$

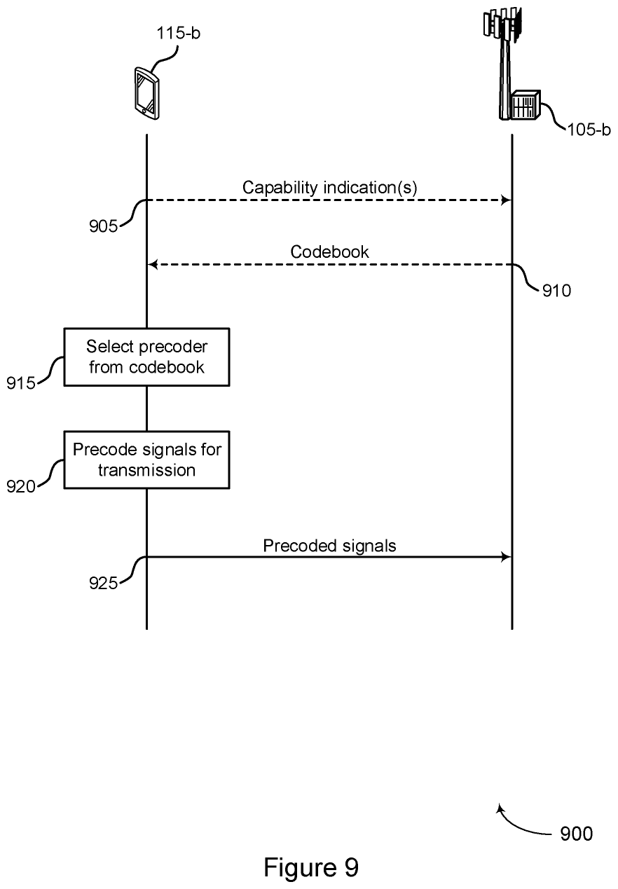

FIG. 9 illustrates an example of a process flow 900 that supports LOS MIMO precoding based on Slepian sequences in accordance with aspects of the present disclosure. Process flow 900 includes a UE 115-b, which may be an example of a UE 115 described with reference to FIGS. 1-8. The UE 115-b may operate in an LOS MIMO mode and may support precoding using Slepian precoders. Process flow 900 also includes a base station 105-b, which may be an example of a base station 105 described with reference to FIGS. 1-8. The process flow 900 may be implemented by or may implement aspects of wireless communications systems 700 or 100. For example, the process flow 900 may support efficient techniques for precoding for LOS MIMO communications. Although FIG. 9 illustrates the UE 115-b as a transmitter, other devices (for example, a base station 105 or a relay) may support similar techniques to the UE 115-b in transmitting.

In the following description of the process flow 900, the signaling exchanged between UE 115-b and base station 105-b may be exchanged in a different order than the example order shown, or the operations performed by the UE 115-b and the base station 105-e may be performed in different orders or at different times. Some operations may also be omitted from the process flow 900, and other operations may be added to the process flow 900.

At 905, the UE 115-b may transmit one or more capability indications to the base station 105-b to indicate one or more capabilities of the UE 115-b. For instance, the UE 115-b may transmit an indication that the UE 115-b is capable of operating in an LOS MIMO mode. The UE 115-b may also transmit an indication that the UE 115-b is capable of utilizing one or more precoders constructed based on Slepian sequences. That is, the UE 115-b may transmit an indication that the UE 115-b is capable of using Slepian precoders for precoding one or more signals.

At 910, the UE 115-b may receive a control message indicating a codebook from which the UE 115-b is to select a precoder for precoding one or more signals for transmission to the base station 105-b. Alternatively, the UE 115-b may determine the codebook from which to select the precoder based on the UE 115-b operating in an LOS MIMO mode without an indication of the codebook from the base station (for example, the codebook may be stored at the UE 115-b). In any case, the codebook may include multiple precoders each constructed based on one or more Slepian sequences, or the codebook may include the one or more Slepian sequences.

At 915, the UE 115-b may select the precoder from the codebook for precoding the one or more signals for transmission to the base station 105-b. The precoder may be based on one or more Slepian sequences associated with a quantity of transmit antennas at the UE 115-b and a bandwidth within which to concentrate the one or more signals. In some examples, a length of each of the one or more Slepian sequences may be equal to a quantity of transmit antennas at the UE 115-b. In some examples, the bandwidth within which to concentrate the one or more signals may be below a threshold bandwidth.

In some implementations, the UE 115-b may select the precoder from the codebook based on a first antenna configuration at the UE 115-b and a second antenna configuration at the base station 105-b. In some examples, the UE 115-b may select the one or more Slepian sequences from the codebook to use to construct the precoder, and the UE 115-b may construct the precoder based on the one or more Slepian sequences.

In some examples, the UE 115-b may include a ULA, and the UE 115-b may select a Slepian precoder from the codebook based on a quantity of receive antennas at the base station 105-b being greater than or equal to the quantity of transmit antennas at the UE 115-b. In some examples, the UE 115-b may include a ULA, and the UE 115-b may select a block-Slepian precoder from the codebook based on a quantity of receive antennas at the base station 105-b being fewer than the quantity of transmit antennas at the UE 115-b. In some examples, the UE 115-b may include a URA, and the UE 115-b may select a first precoder associated with a first axis of the URA and a second precoder associated with a second axis of the URA. The UE 115-b may then determine the precoder for precoding the one or more signals based on a Kronecker product of the first precoder and the second precoder.

At 920, the UE 115-b may precode the one or more signals for transmission to the base station 105-b using the selected precoder. At 925, the UE 115-b may transmit the precoded one or more signals to the base station 105-b. In some examples, the precoder may be constructed based on performing an SVD to generate the one or more Slepian sequences. In some examples, each of the one or more Slepian sequences include an eigenvector of a matrix including values calculated based on the bandwidth within which to concentrate the one or more signals, and one or more dimensions of the matrix may be based on the quantity of transmit antennas at the UE 115-b.

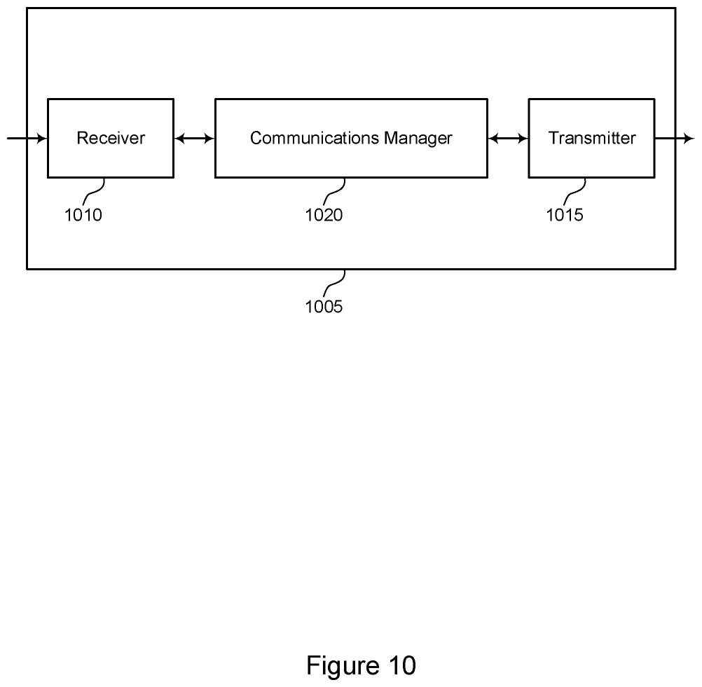

FIG. 10 shows a block diagram of a device 1005 that supports LOS MIMO precoding based on Slepian sequences in accordance with aspects of the present disclosure. The device 1005 may be an example of aspects of a UE 115 or a base station 105 as described herein. The device 1005 may include a receiver 1010, a transmitter 1015, and a communications manager 1020. The communications manager 1020 can be implemented, at least in part, by one or both of a modem and a processor. Each of these components may be in communication with one another (for example, via one or more buses).

The receiver 1010 may provide a means for receiving information such as packets, user data, control information, or any combination thereof associated with various information channels (for example, control channels, data channels, information channels related to LOS MIMO precoding based on Slepian sequences). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (for example, control channels, data channels, information channels related to LOS MIMO precoding based on Slepian sequences). In some examples, the transmitter 1015 may be co-located with a receiver 1010 in a transceiver component. The transmitter 1015 may utilize a single antenna or a set of multiple antennas.

The communications manager 1020, the receiver 1010, the transmitter 1015, or various combinations thereof or various components thereof may be examples of means for performing various aspects of LOS MIMO precoding based on Slepian sequences as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (for example, in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (for example, by executing, by the processor, instructions stored in the memory).

Additionally, or alternatively, in some examples, the communications manager 1020, the receiver 1010, the transmitter 1015, or various combinations or components thereof may be implemented in code (for example, as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a central processing unit (CPU), an ASIC, an FPGA, or any combination of these or other programmable logic devices (for example, configured as or otherwise supporting a means for performing the functions described in the present disclosure).

In some examples, the communications manager 1020 may be configured to perform various operations (for example, receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communication at a first wireless communication device in accordance with examples as disclosed herein. For example, the communications manager 1020 may be configured as or otherwise support a means for selecting a precoder from a codebook for precoding one or more signals for transmission to a second wireless communication device, where the precoder is based on one or more Slepian sequences associated with a quantity of transmit antennas at the first wireless communication device and a bandwidth within which to concentrate the one or more signals. The communications manager 1020 may be configured as or otherwise support a means for precoding the one or more signals for transmission to the second wireless communication device using the selected precoder. The communications manager 1020 may be configured as or otherwise support a means for transmitting the precoded one or more signals to the second wireless communication device.

By including or configuring the communications manager 1020 in accordance with examples as described herein, the device 1005 (for example, a processor controlling or otherwise coupled to the receiver 1010, the transmitter 1015, the communications manager 1020, or a combination thereof) may support techniques for reduced processing and more efficient utilization of communications resources. In particular, because a transmitter may utilize codebook-based precoding for LOS MIMO communications, the transmitter may identify a precoder for precoding signals for transmission to a receiver without signaling or feedback from the receiver. As a result, more resources may be available for other communications in a wireless communications system. Further, because a precoder used for precoding signals for LOS MIMO communications may be constructed based on one or more Slepian sequences, the process of constructing the precoder may be less complex, resulting in reduced processing at a transmitter if the transmitter is expected to construct the precoder.

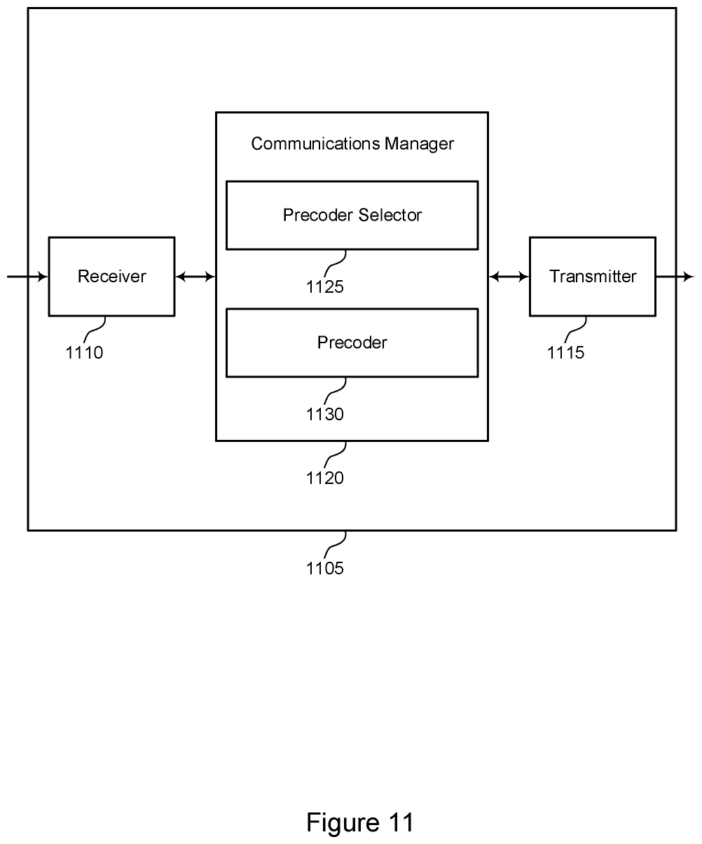

FIG. 11 shows a block diagram of a device 1105 that supports LOS MIMO precoding based on Slepian sequences in accordance with aspects of the present disclosure. The device 1105 may be an example of aspects of a device 1005, a UE 115, or a base station 105 as described herein. The device 1105 may include a receiver 1110, a transmitter 1115, and a communications manager 1120. The communications manager 1120 can be implemented, at least in part, by one or both of a modem and a processor. Each of these components may be in communication with one another (for example, via one or more buses).

The receiver 1110 may provide a means for receiving information such as packets, user data, control information, or any combination thereof associated with various information channels (for example, control channels, data channels, information channels related to LOS MIMO precoding based on Slepian sequences). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (for example, control channels, data channels, information channels related to LOS MIMO precoding based on Slepian sequences). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of LOS MIMO precoding based on Slepian sequences as described herein. For example, the communications manager 1120 may include a precoder selector 1125 a precoder 1130, or any combination thereof. The communications manager 1120 may be an example of aspects of a communications manager 1020 as described herein. In some examples, the communications manager 1120, or various components thereof, may be configured to perform various operations (for example, receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communication at a first wireless communication device in accordance with examples as disclosed herein. The precoder selector 1125 may be configured as or otherwise support a means for selecting a precoder from a codebook for precoding one or more signals for transmission to a second wireless communication device, where the precoder is based on one or more Slepian sequences associated with a quantity of transmit antennas at the first wireless communication device and a bandwidth within which to concentrate the one or more signals. The precoder 1130 may be configured as or otherwise support a means for precoding the one or more signals for transmission to the second wireless communication device using the selected precoder. The communications manager 1120 may be configured as or otherwise support a means for transmitting the precoded one or more signals to the second wireless communication device.

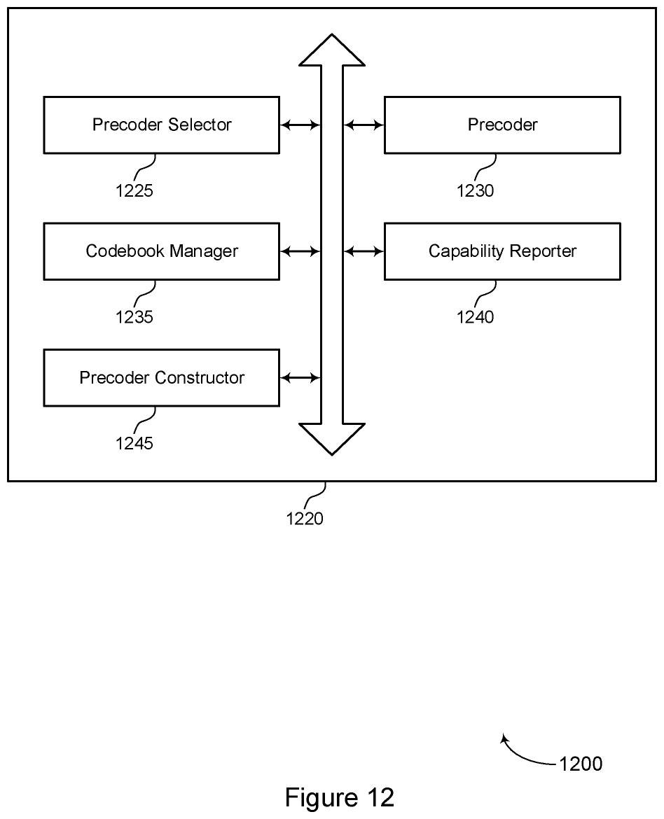

FIG. 12 shows a block diagram 1200 of a communications manager 1220 that supports LOS MIMO precoding based on Slepian sequences in accordance with aspects of the present disclosure. The communications manager 1220 may be an example of aspects of a communications manager 1020, a communications manager 1120, or both, as described herein. The communications manager 1220, or various components thereof, may be an example of means for performing various aspects of LOS MIMO precoding based on Slepian sequences as described herein. For example, the communications manager 1220 may include a precoder selector 1225, a precoder 1230, a codebook manager 1235, a capability reporter 1240, a precoder constructor 1245, or any combination thereof. Each of these components may communicate, directly or indirectly, with one another (for example, via one or more buses).

The communications manager 1220 may support wireless communication at a first wireless communication device in accordance with examples as disclosed herein. The precoder selector 1225 may be configured as or otherwise support a means for selecting a precoder from a codebook for precoding one or more signals for transmission to a second wireless communication device, where the precoder is based on one or more Slepian sequences associated with a quantity of transmit antennas at the first wireless communication device and a bandwidth within which to concentrate the one or more signals. The precoder 1230 may be configured as or otherwise support a means for precoding the one or more signals for transmission to the second wireless communication device using the selected precoder. In some examples, the communications manager 1220 may be configured as or otherwise support a means for transmitting the precoded one or more signals to the second wireless communication device.

In some examples, selecting the precoder from the codebook is based on a first antenna configuration at the first wireless communication device and a second antenna configuration at the second wireless communication device.

In some examples, the codebook manager 1235 may be configured as or otherwise support a means for determining the codebook from which to select the precoder for precoding the one or more signals based on the first wireless communication device operating in a line of sight multiple-input multiple-output mode, where the codebook includes a set of multiple precoders constructed based on Slepian sequences.

In some examples, the first wireless communication device includes a UE, and the codebook manager 1235 may be configured as or otherwise support a means for receiving, from a base station, a control message indicating the codebook from which the UE is to select the precoder for precoding the one or more signals based on the first wireless communication device operating in the line of sight multiple-input multiple-output mode, where the determining is based on receiving the control message.

In some examples, the first wireless communication device includes a UE, and the capability reporter 1240 may be configured as or otherwise support a means for transmitting, to a base station, an indication that the UE is capable of operating in the line of sight multiple-input multiple-output mode.

In some examples, the first wireless communication device includes a UE, and the capability reporter 1240 may be configured as or otherwise support a means for transmitting, to a base station, an indication that the UE is capable of utilizing one or more precoders constructed based on Slepian sequences.

In some examples, to support selecting the precoder from the codebook, the precoder selector 1225 may be configured as or otherwise support a means for selecting the one or more Slepian sequences from the codebook to use to construct the precoder, the method further including. In some examples, to support selecting the precoder from the codebook, the precoder constructor 1245 may be configured as or otherwise support a means for constructing the precoder based on the one or more Slepian sequences.

In some examples, to support selecting the precoder, the precoder selector 1225 may be configured as or otherwise support a means for selecting a Slepian precoder from the codebook based on a quantity of receive antennas at the second wireless communication device being greater than or equal to the quantity of transmit antennas at the first wireless communication device.

In some examples, to support selecting the precoder, the precoder selector 1225 may be configured as or otherwise support a means for selecting a block-Slepian precoder from the codebook based on a quantity of receive antennas at the second wireless communication device being fewer than the quantity of transmit antennas at the first wireless communication device.

In some examples, to support selecting the precoder, the precoder selector 1225 may be configured as or otherwise support a means for selecting a first precoder associated with a first axis of the uniform rectangular antenna array and a second precoder associated with a second axis of the uniform rectangular antenna array. In some examples, to support selecting the precoder, the precoder constructor 1245 may be configured as or otherwise support a means for determining the precoder for precoding the one or more signals based on a Kronecker product of the first precoder and the second precoder.

In some examples, the precoder is constructed based on performing a singular value decomposition to generate the one or more Slepian sequences.

In some examples, each of the one or more Slepian sequences include an eigenvector of a matrix including values calculated based on the bandwidth within which to concentrate the one or more signals. In some examples, one or more dimensions of the matrix are based on the quantity of transmit antennas at the first wireless communication device.

In some examples, the bandwidth within which to concentrate the one or more signals is below a threshold bandwidth.

In some examples, a length of each of the one or more Slepian sequences is equal to the quantity of transmit antennas at the first wireless communication device.

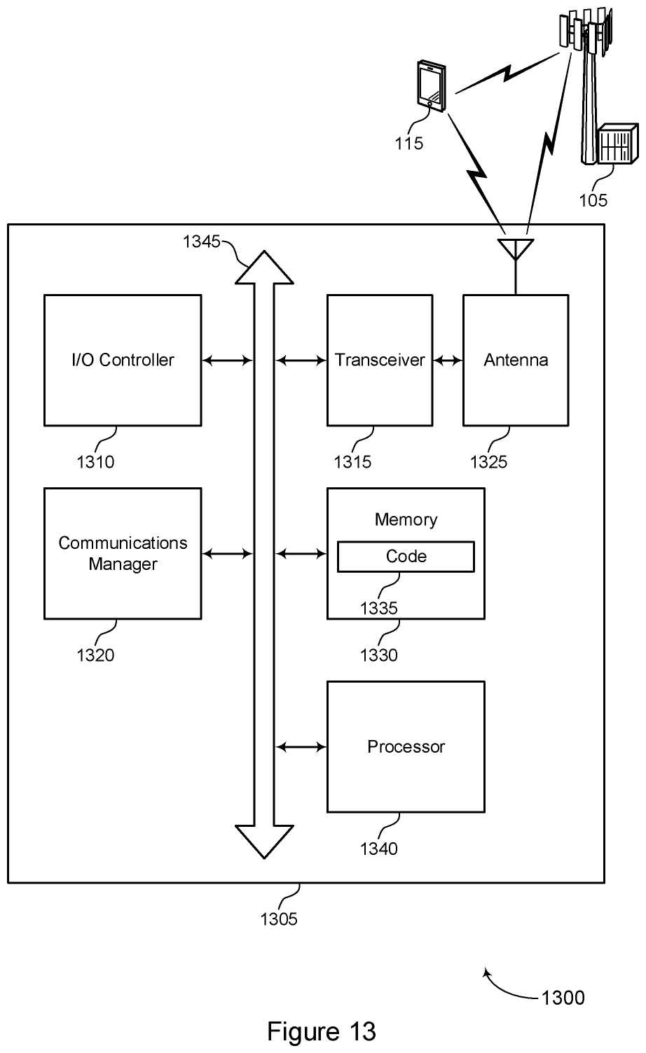

FIG. 13 shows a diagram of a system 1300 including a device 1305 that supports LOS MIMO precoding based on Slepian sequences in accordance with aspects of the present disclosure. The device 1305 may be an example of or include the components of a device 1005, a device 1105, or a UE 115 as described herein. The device 1305 may communicate wirelessly with one or more base stations 105, UEs 115, or any combination thereof. The device 1305 may include components for bi-directional voice and data communications including components for transmitting and receiving communications, such as a communications manager 1320, an input/output (I/O) controller 1310, a transceiver 1315, an antenna 1325, a memory 1330, code 1335, and a processor 1340. These components may be in electronic communication or otherwise coupled (for example, operatively, communicatively, functionally, electronically, electrically) via one or more buses (for example, a bus 1345).

The I/O controller 1310 may manage input and output signals for the device 1305. The I/O controller 1310 may also manage peripherals not integrated into the device 1305. In some cases, the I/O controller 1310 may represent a physical connection or port to an external peripheral. In some cases, the I/O controller 1310 may utilize an operating system such as iOS®, ANDROID®, MS-DOS®, MS-WINDOWS®, OS/2®, UNIX®, LINUX®, or another known operating system. Additionally, or alternatively, the I/O controller 1310 may represent or interact with a modem, a keyboard, a mouse, a touchscreen, or a similar device. In some cases, the I/O controller 1310 may be implemented as part of a processor, such as the processor 1340. In some cases, a user may interact with the device 1305 via the I/O controller 1310 or via hardware components controlled by the I/O controller 1310.

In some cases, the device 1305 may include a single antenna 1325. However, in some other cases, the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The memory 1330 may include random access memory (RAM) and read-only memory (ROM). The memory 1330 may store computer-readable, computer-executable code 1335 including instructions that, when executed by the processor 1340, cause the device 1305 to perform various functions described herein. The code 1335 may be stored in a non-transitory computer-readable medium such as system memory or another type of memory. In some cases, the code 1335 may not be directly executable by the processor 1340 but may cause a computer (for example, when compiled and executed) to perform functions described herein. In some cases, the memory 1330 may contain, among other things, a basic I/O system (BIOS) which may control basic hardware or software operation such as the interaction with peripheral components or devices.

The processor 1340 may include an intelligent hardware device (for example, a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some other cases, a memory controller may be integrated into the processor 1340. The processor 1340 may be configured to execute computer-readable instructions stored in a memory (for example, the memory 1330) to cause the device 1305 to perform various functions (for example, functions or tasks supporting LOS MIMO precoding based on Slepian sequences). For example, the device 1305 or a component of the device 1305 may include a processor 1340 and memory 1330 coupled to the processor 1340, the processor 1340 and memory 1330 configured to perform various functions described herein.

The communications manager 1320 may support wireless communication at a first wireless communication device in accordance with examples as disclosed herein. For example, the communications manager 1320 may be configured as or otherwise support a means for selecting a precoder from a codebook for precoding one or more signals for transmission to a second wireless communication device, where the precoder is based on one or more Slepian sequences associated with a quantity of transmit antennas at the first wireless communication device and a bandwidth within which to concentrate the one or more signals. The communications manager 1320 may be configured as or otherwise support a means for precoding the one or more signals for transmission to the second wireless communication device using the selected precoder. The communications manager 1320 may be configured as or otherwise support a means for transmitting the precoded one or more signals to the second wireless communication device.

By including or configuring the communications manager 1320 in accordance with examples as described herein, the device 1305 may support techniques for reduced processing and more efficient utilization of communications resources. In particular, because a transmitter may utilize codebook-based precoding for LOS MIMO communications, the transmitter may identify a precoder for precoding signals for transmission to a receiver without signaling or feedback from the receiver. As a result, more resources may be available for other communications in a wireless communications system. Further, because a precoder used for precoding signals for LOS MIMO communications may be constructed based on one or more Slepian sequences, the process of constructing the precoder may be less complex, resulting in reduced processing at a transmitter if the transmitter is expected to construct the precoder.

In some examples, the communications manager 1320 may be configured to perform various operations (for example, receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the processor 1340, the memory 1330, the code 1335, or any combination thereof. For example, the code 1335 may include instructions executable by the processor 1340 to cause the device 1305 to perform various aspects of LOS MIMO precoding based on Slepian sequences as described herein, or the processor 1340 and the memory 1330 may be otherwise configured to perform or support such operations.

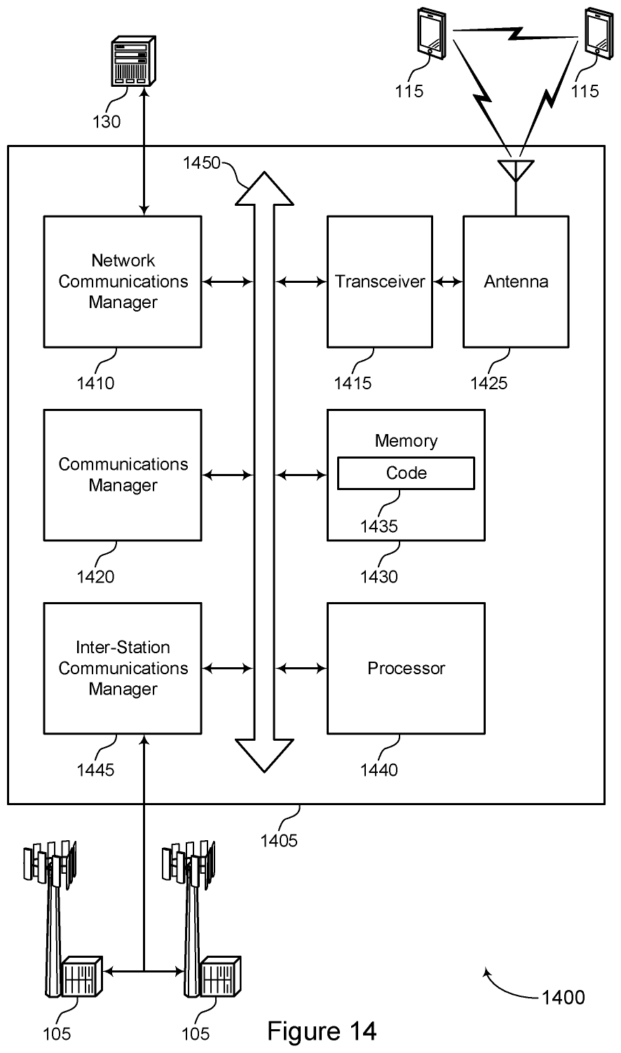

FIG. 14 shows a diagram of a system 1400 including a device 1405 that supports LOS MIMO precoding based on Slepian sequences in accordance with aspects of the present disclosure. The device 1405 may be an example of or include the components of a device 1005, a device 1105, or a base station 105 as described herein. The device 1405 may communicate wirelessly with one or more base stations 105, UEs 115, or any combination thereof. The device 1405 may include components for bi-directional voice and data communications including components for transmitting and receiving communications, such as a communications manager 1420, a network communications manager 1410, a transceiver 1415, an antenna 1425, a memory 1430, code 1435, a processor 1440, and an inter-station communications manager 1445. These components may be in electronic communication or otherwise coupled (for example, operatively, communicatively, functionally, electronically, electrically) via one or more buses (for example, a bus 1450).

The network communications manager 1410 may manage communications with a core network 130 (for example, via one or more wired backhaul links). For example, the network communications manager 1410 may manage the transfer of data communications for client devices, such as one or more UEs 115.

In some cases, the device 1405 may include a single antenna 1425. However, in some other cases the device 1405 may have more than one antenna 1425, which may be capable of concurrently transmitting or receiving multiple wireless transmissions. The transceiver 1415 may communicate bi-directionally, via the one or more antennas 1425, wired, or wireless links as described herein. For example, the transceiver 1415 may represent a wireless transceiver and may communicate bi-directionally with another wireless transceiver. The transceiver 1415 may also include a modem to modulate the packets, to provide the modulated packets to one or more antennas 1425 for transmission, and to demodulate packets received from the one or more antennas 1425. The transceiver 1415, or the transceiver 1415 and one or more antennas 1425, may be an example of a transmitter 1015, a transmitter 1115, a receiver 1010, a receiver 1110, or any combination thereof or component thereof, as described herein.

The memory 1430 may include RAM and ROM. The memory 1430 may store computer-readable, computer-executable code 1435 including instructions that, when executed by the processor 1440, cause the device 1405 to perform various functions described herein. The code 1435 may be stored in a non-transitory computer-readable medium such as system memory or another type of memory. In some cases, the code 1435 may not be directly executable by the processor 1440 but may cause a computer (for example, when compiled and executed) to perform functions described herein. In some cases, the memory 1430 may contain, among other things, a BIOS which may control basic hardware or software operation such as the interaction with peripheral components or devices.

The processor 1440 may include an intelligent hardware device (for example, a general-purpose processor, a DSP, a CPU, a microcontroller, an ASIC, an FPGA, a programmable logic device, a discrete gate or transistor logic component, a discrete hardware component, or any combination thereof). In some cases, the processor 1440 may be configured to operate a memory array using a memory controller. In some other cases, a memory controller may be integrated into the processor 1440. The processor 1440 may be configured to execute computer-readable instructions stored in a memory (for example, the memory 1430) to cause the device 1405 to perform various functions (for example, functions or tasks supporting LOS MIMO precoding based on Slepian sequences). For example, the device 1405 or a component of the device 1405 may include a processor 1440 and memory 1430 coupled to the processor 1440, the processor 1440 and memory 1430 configured to perform various functions described herein.

The inter-station communications manager 1445 may manage communications with other base stations 105, and may include a controller or scheduler for controlling communications with UEs 115 in cooperation with other base stations 105. For example, the inter-station communications manager 1445 may coordinate scheduling for transmissions to UEs 115 for various interference mitigation techniques such as beamforming or joint transmission. In some examples, the inter-station communications manager 1445 may provide an X2 interface within an LTE/LTE-A wireless communications network technology to provide communication between base stations 105.

The communications manager 1420 may support wireless communication at a first wireless communication device in accordance with examples as disclosed herein. For example, the communications manager 1420 may be configured as or otherwise support a means for selecting a precoder from a codebook for precoding one or more signals for transmission to a second wireless communication device, where the precoder is based on one or more Slepian sequences associated with a quantity of transmit antennas at the first wireless communication device and a bandwidth within which to concentrate the one or more signals. The communications manager 1420 may be configured as or otherwise support a means for precoding the one or more signals for transmission to the second wireless communication device using the selected precoder. The communications manager 1420 may be configured as or otherwise support a means for transmitting the precoded one or more signals to the second wireless communication device.

By including or configuring the communications manager 1420 in accordance with examples as described herein, the device 1405 may support techniques for reduced processing and more efficient utilization of communications resources. In particular, because a transmitter may utilize codebook-based precoding for LOS MIMO communications, the transmitter may identify a precoder for precoding signals for transmission to a receiver without signaling or feedback from the receiver. As a result, more resources may be available for other communications in a wireless communications system. Further, because a precoder used for precoding signals for LOS MIMO communications may be constructed based on one or more Slepian sequences, the process of constructing the precoder may be less complex, resulting in reduced processing at a transmitter if the transmitter is expected to construct the precoder.

In some examples, the communications manager 1420 may be configured to perform various operations (for example, receiving, monitoring, transmitting) using or otherwise in cooperation with the transceiver 1415, the one or more antennas 1425, or any combination thereof. Although the communications manager 1420 is illustrated as a separate component, in some examples, one or more functions described with reference to the communications manager 1420 may be supported by or performed by the processor 1440, the memory 1430, the code 1435, or any combination thereof. For example, the code 1435 may include instructions executable by the processor 1440 to cause the device 1405 to perform various aspects of LOS MIMO precoding based on Slepian sequences as described herein, or the processor 1440 and the memory 1430 may be otherwise configured to perform or support such operations.

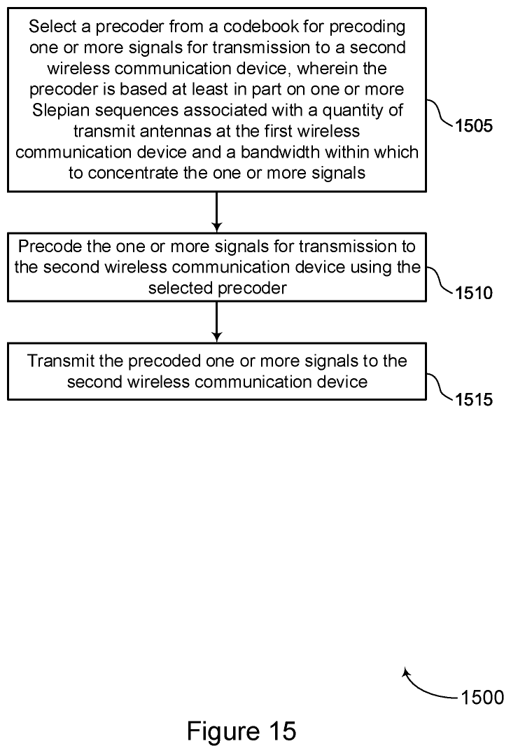

FIG. 15 shows a flowchart illustrating a method 1500 that supports LOS MIMO precoding based on Slepian sequences in accordance with aspects of the present disclosure. The operations of the method 1500 may be implemented by a UE or a base station or its components as described herein. For example, the operations of the method 1500 may be performed by a UE 115 or a base station 105 as described with reference to FIGS. 1-14. In some examples, a UE or a base station may execute a set of instructions to control the functional elements of the UE or the base station to perform the described functions. Additionally, or alternatively, the UE or the base station may perform aspects of the described functions using special-purpose hardware.

At 1505, the method may include selecting a precoder from a codebook for precoding one or more signals for transmission to a second wireless communication device, where the precoder is based on one or more Slepian sequences associated with a quantity of transmit antennas at the first wireless communication device and a bandwidth within which to concentrate the one or more signals. The operations of 1505 may be performed in accordance with examples as disclosed herein. In some examples, aspects of the operations of 1505 may be performed by a precoder selector 1225 as described with reference to FIG. 12.

At 1510, the method may include precoding the one or more signals for transmission to the second wireless communication device using the selected precoder. The operations of 1510 may be performed in accordance with examples as disclosed herein. In some examples, aspects of the operations of 1510 may be performed by a precoder 1230 as described with reference to FIG. 12.

At 1515, the method may include transmitting the precoded one or more signals to the second wireless communication device. The operations of 1515 may be performed in accordance with examples as disclosed herein. In some examples, aspects of the operations of 1515 may be performed by a precoder 1230 as described with reference to FIG. 12.

The following provides an overview of aspects of the present disclosure:

Aspect 1: A method for wireless communication at a first wireless communication device, comprising: selecting a precoder from a codebook for precoding one or more signals for transmission to a second wireless communication device, wherein the precoder is based at least in part on one or more Slepian sequences associated with a quantity of transmit antennas at the first wireless communication device and a bandwidth within which to concentrate the one or more signals: precoding the one or more signals for transmission to the second wireless communication device using the selected precoder; and transmitting the precoded one or more signals to the second wireless communication device.

Aspect 2: The method of aspect 1, wherein selecting the precoder from the codebook is based at least in part on a first antenna configuration at the first wireless communication device and a second antenna configuration at the second wireless communication device.

Aspect 3: The method of any of aspects 1 through 2, further comprising: determining the codebook from which to select the precoder for precoding the one or more signals based at least in part on the first wireless communication device operating in a line of sight multiple-input multiple-output mode, wherein the codebook comprises a plurality of precoders constructed based at least in part on Slepian sequences.

Aspect 4: The method of aspect 3, wherein the first wireless communication device comprises a UE, and the method further comprises: receiving, from a base station, a control message indicating the codebook from which the UE is to select the precoder for precoding the one or more signals based at least in part on the first wireless communication device operating in the line of sight multiple-input multiple-output mode, wherein the determining is based at least in part on receiving the control message.

Aspect 5: The method of any of aspects 3 through 4, wherein the first wireless communication device comprises a UE, and the method further comprises: transmitting, to a base station, an indication that the UE is capable of operating in the line of sight multiple-input multiple-output mode, wherein determining the codebook from which to select the precoder for precoding the one or more signals is based at least in part on transmitting the indication.

Aspect 6: The method of any of aspects 1 through 5, wherein the first wireless communication device comprises a UE, and the method further comprises: transmitting, to a base station, an indication that the UE is capable of utilizing one or more precoders constructed based at least in part on Slepian sequences, wherein determining the codebook from which to select the precoder for precoding the one or more signals is based at least in part on transmitting the indication.

Aspect 7: The method of any of aspects 1 through 6, wherein selecting the precoder from the codebook comprises: selecting the one or more Slepian sequences from the codebook to use to construct the precoder, the method further comprising: constructing the precoder based at least in part on the one or more Slepian sequences.

Aspect 8: The method of any of aspects 1 through 7, wherein the first wireless communication device comprises a uniform linear antenna array, and wherein selecting the precoder comprises: selecting a Slepian precoder from the codebook based at least in part on a quantity of receive antennas at the second wireless communication device being greater than or equal to the quantity of transmit antennas at the first wireless communication device.

Aspect 9: The method of any of aspects 1 through 8, wherein the first wireless communication device comprises a uniform linear antenna array, and wherein selecting the precoder comprises: selecting a block-Slepian precoder from the codebook based at least in part on a quantity of receive antennas at the second wireless communication device being fewer than the quantity of transmit antennas at the first wireless communication device.

Aspect 10: The method of any of aspects 1 through 9, wherein the first wireless communication device comprises a uniform rectangular antenna array, and wherein selecting the precoder comprises: selecting a first precoder associated with a first axis of the uniform rectangular antenna array and a second precoder associated with a second axis of the uniform rectangular antenna array; and determining the precoder for precoding the one or more signals based at least in part on a Kronecker product of the first precoder and the second precoder.

Aspect 11: The method of any of aspects 1 through 10, wherein the precoder is constructed based at least in part on performing a singular value decomposition to generate the one or more Slepian sequences.

Aspect 12: The method of any of aspects 1 through 11, wherein each of the one or more Slepian sequences comprise an eigenvector of a matrix comprising values calculated based at least in part on the bandwidth within which to concentrate the one or more signals, and one or more dimensions of the matrix are based at least in part on the quantity of transmit antennas at the first wireless communication device.

Aspect 13: The method of any of aspects 1 through 12, wherein the bandwidth within which to concentrate the one or more signals is below a threshold bandwidth.

Aspect 14: The method of any of aspects 1 through 13, wherein a length of each of the one or more Slepian sequences is equal to the quantity of transmit antennas at the first wireless communication device.

Aspect 15: An apparatus for wireless communication at a first wireless communication device, comprising a processor; memory coupled with the processor; and instructions stored in the memory and executable by the processor to cause the apparatus to perform a method of any of aspects 1 through 14.

Aspect 16: An apparatus for wireless communication at a first wireless communication device, comprising at least one means for performing a method of any of aspects 1 through 14.

Aspect 17: A non-transitory computer-readable medium storing code for wireless communication at a first wireless communication device, the code comprising instructions executable by a processor to perform a method of any of aspects 1 through 14.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (for example, a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (that is, A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a first wireless communication device, comprising:
selecting a precoder from a codebook for precoding one or more signals for transmission to a second wireless communication device, wherein the precoder is based at least in part on one or more Slepian sequences associated with a quantity of transmit antennas at the first wireless communication device and a bandwidth within which to concentrate the one or more signals;
precoding the one or more signals for transmission to the second wireless communication device using the selected precoder; and
transmitting the precoded one or more signals to the second wireless communication device.

2. The method of claim 1, wherein selecting the precoder from the codebook is based at least in part on a first antenna configuration at the first wireless communication device and a second antenna configuration at the second wireless communication device.

3. The method of claim 1, further comprising determining the codebook from which to select the precoder for precoding the one or more signals based at least in part on the first wireless communication device operating in a line of sight multiple-input multiple-output mode, wherein the codebook comprises a plurality of precoders constructed based at least in part on Slepian sequences.

4. The method of claim 3, wherein the first wireless communication device comprises a user equipment (UE), and the method further comprises receiving, from a base station, a control message indicating the codebook from which the UE is to select the precoder for precoding the one or more signals based at least in part on the first wireless communication device operating in the line of sight multiple-input multiple-output mode, wherein the determining is based at least in part on receiving the control message.

5. The method of claim 3, wherein the first wireless communication device comprises a user equipment (UE), and the method further comprises transmitting, to a base station, an indication that the UE is capable of operating in the line of sight multiple-input multiple-output mode.

6. The method of claim 1, wherein the first wireless communication device comprises a user equipment (UE), and the method further comprises transmitting, to a base station, an indication that the UE is capable of utilizing one or more precoders constructed based at least in part on Slepian sequences.

7. The method of claim 1, wherein selecting the precoder from the codebook comprises:
selecting the one or more Slepian sequences from the codebook to use to construct the precoder, the method further comprising:
constructing the precoder based at least in part on the one or more Slepian sequences.

8. The method of claim 1, wherein the first wireless communication device comprises a uniform linear antenna array, and wherein selecting the precoder comprises selecting a Slepian precoder from the codebook based at least in part on a quantity of receive antennas at the second wireless communication device being greater than or equal to the quantity of transmit antennas at the first wireless communication device.

9. The method of claim 1, wherein the first wireless communication device comprises a uniform linear antenna array, and wherein selecting the precoder comprises selecting a block-Slepian precoder from the codebook based at least in part on a quantity of receive antennas at the second wireless communication device being fewer than the quantity of transmit antennas at the first wireless communication device.

10. The method of claim 1, wherein the first wireless communication device comprises a uniform rectangular antenna array, and wherein selecting the precoder comprises:
selecting a first precoder associated with a first axis of the uniform rectangular antenna array and a second precoder associated with a second axis of the uniform rectangular antenna array; and
determining the precoder for precoding the one or more signals based at least in part on a Kronecker product of the first precoder and the second precoder.

11. The method of claim 1, wherein the precoder is constructed based at least in part on performing a singular value decomposition to generate the one or more Slepian sequences.

12. The method of claim 1, wherein:
each of the one or more Slepian sequences comprise an eigenvector of a matrix comprising values calculated based at least in part on the bandwidth within which to concentrate the one or more signals, and
one or more dimensions of the matrix are based at least in part on the quantity of transmit antennas at the first wireless communication device.

13. The method of claim 1, wherein the bandwidth within which to concentrate the one or more signals is below a threshold bandwidth.

14. The method of claim 1, wherein a length of each of the one or more Slepian sequences is equal to the quantity of transmit antennas at the first wireless communication device.

15. An apparatus for wireless communication at a first wireless communication device, comprising:
a processor;
memory coupled with the processor; and
instructions stored in the memory and executable by the processor to cause the apparatus to:
select a precoder from a codebook for precoding one or more signals for transmission to a second wireless communication device, wherein the precoder is based at least in part on one or more Slepian sequences associated with a quantity of transmit antennas at the first wireless communication device and a bandwidth within which to concentrate the one or more signals;
precode the one or more signals for transmission to the second wireless communication device using the selected precoder; and
transmit the precoded one or more signals to the second wireless communication device.

16. The apparatus of claim 15, wherein selecting the precoder from the codebook is based at least in part on a first antenna configuration at the first wireless communication device and a second antenna configuration at the second wireless communication device.

17. The apparatus of claim 15, wherein the instructions are further executable by the processor to cause the apparatus to determine the codebook from which to select the precoder for precoding the one or more signals based at least in part on the first wireless communication device operating in a line of sight multiple-input multiple-output mode, wherein the codebook comprises a plurality of precoders constructed based at least in part on Slepian sequences.

18. The apparatus of claim 17, wherein the first wireless communication device comprises a user equipment (UE), and the instructions are further executable by the processor to cause the apparatus to receive, from a base station, a control message indicating the codebook from which the UE is to select the precoder for precoding the one or more signals based at least in part on the first wireless communication device operating in the line of sight multiple-input multiple-output mode, wherein the determining is based at least in part on receiving the control message.

19. The apparatus of claim 17, wherein the first wireless communication device comprises a user equipment (UE), and the instructions are further executable by the processor to cause the apparatus to transmit, to a base station, an indication that the UE is capable of operating in the line of sight multiple-input multiple-output mode.

20. The apparatus of claim 15, wherein the first wireless communication device comprises a user equipment (UE), and the instructions are further executable by the processor to cause the apparatus to transmit, to a base station, an indication that the UE is capable of utilizing one or more precoders constructed based at least in part on Slepian sequences.

21. The apparatus of claim 15, wherein the instructions to select the precoder from the codebook are executable by the processor to cause the apparatus to:
select the one or more Slepian sequences from the codebook to use to construct the precoder, the method further comprising:
construct the precoder based at least in part on the one or more Slepian sequences.

22. The apparatus of claim 15, wherein the instructions to select the precoder are executable by the processor to cause the apparatus to select a Slepian precoder from the codebook based at least in part on a quantity of receive antennas at the second wireless communication device being greater than or equal to the quantity of transmit antennas at the first wireless communication device.

23. The apparatus of claim 15, wherein the instructions to select the precoder are executable by the processor to cause the apparatus to select a block-Slepian precoder from the codebook based at least in part on a quantity of receive antennas at the second wireless communication device being fewer than the quantity of transmit antennas at the first wireless communication device.

24. The apparatus of claim 15, wherein the instructions to select the precoder are executable by the processor to cause the apparatus to:
select a first precoder associated with a first axis of the uniform rectangular antenna array and a second precoder associated with a second axis of the uniform rectangular antenna array; and
determine the precoder for precoding the one or more signals based at least in part on a Kronecker product of the first precoder and the second precoder.

25. The apparatus of claim 15, wherein the precoder is constructed based at least in part on performing a singular value decomposition to generate the one or more Slepian sequences.

26. The apparatus of claim 15, wherein:
each of the one or more Slepian sequences comprise an eigenvector of a matrix comprising values calculated based at least in part on the bandwidth within which to concentrate the one or more signals, and
one or more dimensions of the matrix are based at least in part on the quantity of transmit antennas at the first wireless communication device.

27. The apparatus of claim 15, wherein the bandwidth within which to concentrate the one or more signals is below a threshold bandwidth.

28. The apparatus of claim 15, wherein a length of each of the one or more Slepian sequences is equal to the quantity of transmit antennas at the first wireless communication device.

29. An apparatus for wireless communication at a first wireless communication device, comprising:
means for selecting a precoder from a codebook for precoding one or more signals for transmission to a second wireless communication device, wherein the precoder is based at least in part on one or more Slepian sequences associated with a quantity of transmit antennas at the first wireless communication device and a bandwidth within which to concentrate the one or more signals;
means for precoding the one or more signals for transmission to the second wireless communication device using the selected precoder; and
means for transmitting the precoded one or more signals to the second wireless communication device.

30. A non-transitory computer-readable medium storing code for wireless communication at a first wireless communication device, the code comprising instructions executable by a processor to:
select a precoder from a codebook for precoding one or more signals for transmission to a second wireless communication device, wherein the precoder is based at least in part on one or more Slepian sequences associated with a quantity of transmit antennas at the first wireless communication device and a bandwidth within which to concentrate the one or more signals;
precode the one or more signals for transmission to the second wireless communication device using the selected precoder, and
transmit the precoded one or more signals to the second wireless communication device.
